(19) United States
(12) Patent Application Publication
(10) Pub. No.: US 2025/0184456 A1
(43) Pub. Date: Jun. 5, 2025

(54) TRANSPARENT PROJECTION FILM STRUCTURE

(71) Applicant: INDUSTRIAL TECHNOLOGY RESEARCH INSTITUTE, Hsinchu (TW)

(72) Inventors: Yu- Hsiang LIU, Chiayi City (TW); Yi-Hsiang HUANG, Changhua City (TW); Chia-Ping LIN, Taipei City (TW); Hung TSOU, Zhubei City (TW); Szu-Wei WU, Taoyuan City (TW)

(73) Assignee: INDUSTRIAL TECHNOLOGY RESEARCH INSTITUTE, Hsinchu (TW)

(21) Appl. No.: 18/675,937

(22) Filed: May 28, 2024

(30) Foreign Application Priority Data
Dec. 5, 2023 (TW) 112147151

(51) Int. Cl. H04N 9/31

(52) U.S. Cl. CPC H04N 9/3152; H04N 9/3158

(57) ABSTRACT

A transparent projection film structure is provided. The transparent projection film structure includes a base layer and a patterned light-guiding layer disposed on the base layer. In a cross-sectional view, the patterned light-guiding layer has light-guiding units, and hollow areas are formed between the light-guiding units. The transparent projection film structure also includes a scattering layer disposed on the base layer and includes scattering particles. At least some of the scattering particles correspond to the patterned light-guiding layer.

### CROSS REFERENCE TO RELATED APPLICATIONS

This application claims priority of Taiwan Patent Application No. 112147151, filed on Dec. 5, 2023, the entirety of which is incorporated by reference herein.

### TECHNICAL FIELD

The present disclosure relates to a transparent projection film structure.

### BACKGROUND

With the development of display technology, electronic devices equipped with display screens are increasingly being applied and diversified. Consequently, viewers' demands for higher display quality in their display screens are also steadily increasing.

Transparent display technology may be broadly classified into transmissive transparent displays and projective transparent displays. Transmissive transparent displays are created by making the display panel transparent through the use of transparent materials or by creating perforations, while projective transparent displays achieve a transparent display effect by projecting images onto a structure that is both projectable and transparent. However, the current transparent projection display devices on the market are lacking, and new models are required that possess high transmittance, high image clarity, and are suitable for both long and short focal lengths.

### SUMMARY

Some embodiments of the present disclosure include a transparent projection film structure. The transparent projection film structure includes a base layer and a patterned light-guiding layer disposed on the base layer. In a cross-sectional view, the patterned light-guiding layer has light-guiding units, and hollow areas are formed between the light-guiding units. The transparent projection film structure also includes a scattering layer disposed on the base layer and includes scattering particles. At least some of the scattering particles correspond to the patterned light-guiding layer.

### BRIEF DESCRIPTION OF THE DRAWINGS

Aspects of the embodiments of the present disclosure can be understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a partial cross-sectional view illustrating the transparent projection film structure according to some embodiments of the present disclosure.

FIG. 2 is a partial top view illustrating the patterned light-guiding layer according to some embodiments of the present disclosure.

FIG. 3 is a partial cross-sectional view illustrating the transparent projection film structure according to some other embodiments of the present disclosure.

FIG. 4 is a partial cross-sectional view illustrating the transparent projection film structure according to some other embodiments of the present disclosure.

FIG. 5 is a partial cross-sectional view illustrating the transparent projection film structure according to some other embodiments of the present disclosure.

FIG. 6 is a partial cross-sectional view illustrating the transparent projection film structure according to some other embodiments of the present disclosure.

FIG. 7 is a partial cross-sectional view illustrating the transparent projection film structure according to some other embodiments of the present disclosure.

FIG. 8 is a partial cross-sectional view illustrating the transparent projection film structure according to some other embodiments of the present disclosure.

FIG. 9 is a partial cross-sectional view illustrating the transparent projection film structure according to some other embodiments of the present disclosure.

FIG. 10 is a partial cross-sectional view illustrating the transparent projection film structure according to some other embodiments of the present disclosure.

FIG. 11 is a partial cross-sectional view illustrating the transparent projection film structure according to some other embodiments of the present disclosure.

FIG. 12 is a partial cross-sectional view of illustrating the transparent projection film structure according to some other embodiments of the present disclosure.

### DETAILED DESCRIPTION

The following disclosure provides many different embodiments, or examples, for implementing different features of the subject matter provided. Specific examples of components and arrangements are described below to simplify the present disclosure. These are, of course, merely examples and are not intended to be limiting. For example, a first feature is formed on a second feature in the description that follows may include embodiments in which the first feature and second feature are formed in direct contact, and may also include embodiments in which additional features may be formed between the first feature and second feature, so that the first feature and second feature may not be in direct contact.

It should be understood that additional steps may be implemented before, during, or after the illustrated methods, and some steps might be replaced or omitted in other embodiments of the illustrated methods.

Furthermore, spatially relative terms, such as “beneath,” “below,” “lower,” “on,” “above,” “upper” and the like, may be used herein for ease of description to describe one element or feature's relationship to other elements or features as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present disclosure, the terms “about,” “approximately” and “substantially” typically mean within +/−20% of the stated value, more typically within +/−10% of the stated value, or within +/−5% of the stated value, or within +/−3% of the stated value, or within +/−2% of the stated value, or within +/−1% of the stated value and even within +/−0.5% of the stated value. The stated value of the present disclosure is an approximate value. That is, when there is no specific description of the terms “about,” “approximately” and “substantially”, the stated value includes the meaning of “about,” “approximately” or “substantially”.

Unless otherwise defined, all terms (including technical and scientific terms) used herein have the same meaning as commonly understood by one of ordinary skill in the art to which the present disclosure belongs. It should be understood that terms such as those defined in commonly used dictionaries should be interpreted as having a meaning that is consistent with their meaning in the context of the relevant art and will not be interpreted in an idealized or overly formal sense unless expressly so defined in the embodiments of the present disclosure.

The present disclosure may repeat reference numerals and/or letters in following embodiments. This repetition is for the purpose of simplicity and clarity and does not in itself dictate a relationship between the various embodiments and/or configurations discussed.

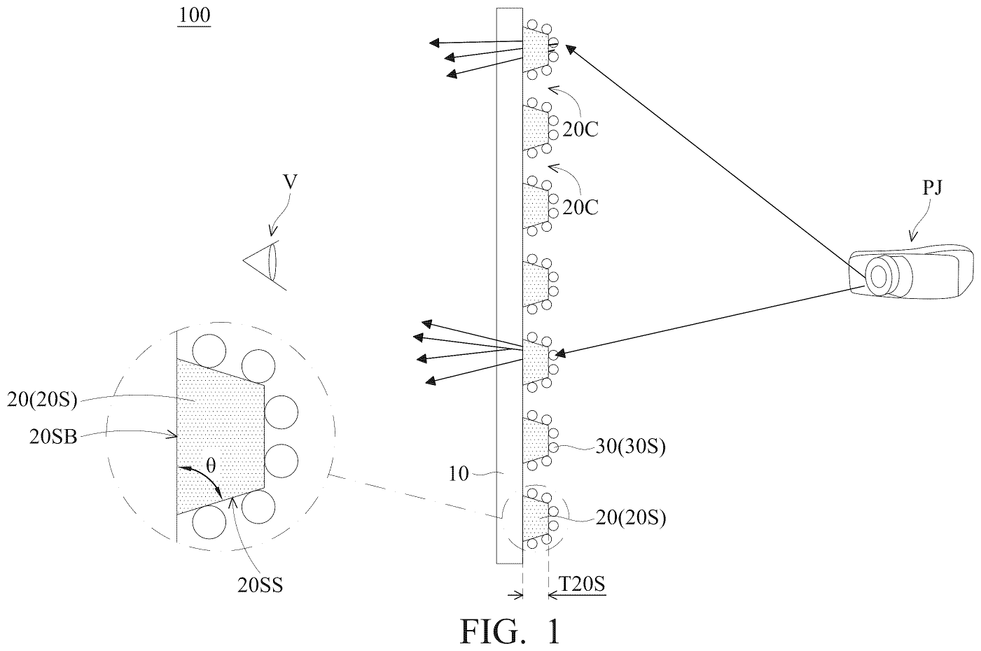

FIG. 1 is a partial cross-sectional view illustrating the transparent projection film structure 100 according to some embodiments of the present disclosure. It should be noted that some components of the transparent projection film structure 100 have been omitted in FIG. 1 for the sake of brevity.

Referring to FIG. 1, in some embodiments, the transparent projection film structure 100 includes a base layer 10. For example, the base layer 10 may include silicon dioxide (SiO₂, such as glass) or polyimide (PI). In some embodiments, the transparency of the base layer 10 is about 30% to about 95%, and the haze of the base layer 10 is less than or equal to about 5%.

Referring to FIG. 1, in some embodiments, the transparent projection film structure 100 also includes a patterned light-guiding layer 20 disposed on the base layer 10. In the cross-sectional view shown in FIG. 1, the patterned light-guiding layer 20 has multiple light-guiding units 20S, and multiple hollow areas 20C are formed between the light-guiding units 20S.

For example, the patterned light-guiding layer 20 may include materials such as acrylic (for instance, poly(methyl methacrylate), PMMA), epoxy resin, silicone resin, polyurethane, other suitable materials, or a combination thereof, but the embodiments of the present disclosure are not limited to these. Additionally, the light-guiding units 20S of the patterned light-guiding layer 20 may be formed by methods such as photoresist reflow method, hot embossing method, other appropriate methods, or a combination thereof. For instance, the steps to form the patterned light-guiding layer 20 (light-guiding units 20S) may include spin coating, photolithography, etching, other suitable processes, or a combination thereof, but the embodiments of the present disclosure are not limited to these.

In some embodiments, the refractive index of (the light-guiding units 20S of) the patterned light-guiding layer 20 is about 1.5 to about 2, and the transmittance of (the light-guiding units 20S of) the patterned light-guiding layer 20 is greater than or equal to about 80%. In some embodiments, the haze of (the light-guiding units 20S of) the patterned light-guiding layer 20 is less than or equal to about 15%. Moreover, as shown in FIG. 1, in some embodiments, the light-guiding units 20S may be trapezoidal, and the thickness T20S of the light-guiding units 20S, for example, is between about 0.5 μm and about 12 μm. The shape of the light-guiding units 20S is not limited by the present disclosure and may be designed according to actual needs.

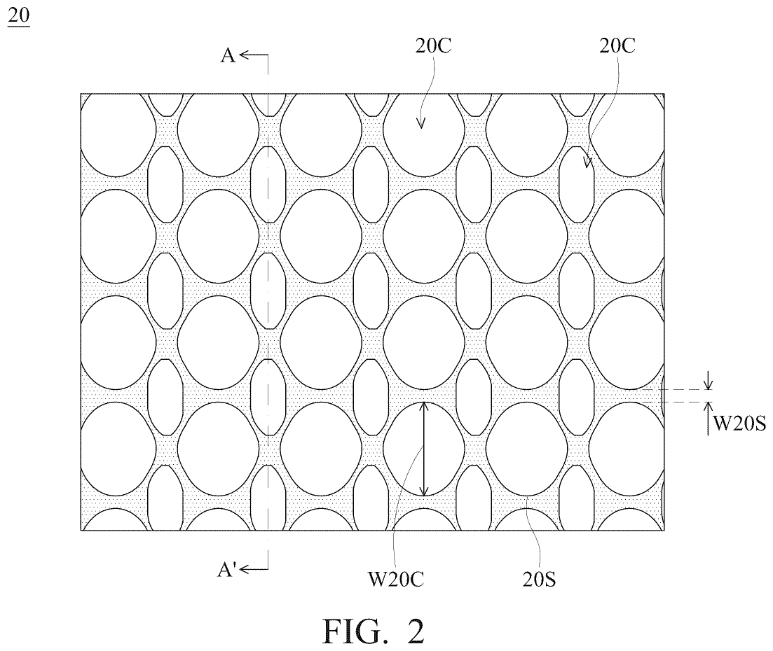

FIG. 2 is a partial top view illustrating the patterned light-guiding layer 20 according to some embodiments of the present disclosure. For example, FIG. 1 may be a cross-sectional view along line A-A′ of FIG. 2, but the present disclosure is not limited to thereto.

As shown in FIG. 2, in some embodiments, in the top view of the patterned light-guiding layer 20, each hollow area 20C is formed similar to as a circle or an ellipse, but the present disclosure is not limited to thereto. In some other embodiments, the hollow areas 20C may be formed, for example, as polygons with internal angles greater than about 135°.

As shown in FIG. 2, in some embodiments, in the top view of the patterned light-guiding layer 20, the maximum width W20C of the hollow areas 20C is, for example, between about 50 μm and about 300 μm. Moreover, in some embodiments, in the top view of the patterned light-guiding layer 20, the minimum width W20S of the arrangement area of the light-guiding units 20S is, for example, between about 3 μm and about 100 μm.

As shown in FIG. 2, in the top view of the patterned light-guiding layer 20, the light-guiding units 20S of the patterned light-guiding layer 20 form a symmetrical structure, but the present disclosure is not limited thereto. In some other embodiments, the light-guiding units 20S of the patterned light-guiding layer 20 may also form an asymmetric structure.

In traditional applications of light-guiding layers for projection films, they usually have multiple openings (i.e., hollow areas) with fixed size and aligned arrangement. When light passes through these openings, diffraction phenomena accumulate, and the denser and more regularly symmetrical the openings, the more severe the blurring effect. In contrast, the transparent projection film structure 100 of the present disclosure may include the patterned light-guiding layer 20 as shown in FIG. 2. By adjusting the configuration of the openings (i.e., hollow areas 20C) of the patterned light-guiding layer 20 and arranging them in a staggered manner, the periodic structure is disrupted, thereby reducing diffraction phenomena and making images projected onto the transparent projection film structure 100 clearer. The shape of the hollow areas 20C may be designed according to actual needs, such as circular, elliptical, polygonal, or irregular.

In some embodiments, the ratio of the maximum width W20C of the hollow areas 20C to the thickness T20S (see FIG. 1) of the light-guiding units 20S is greater than about 10:1, and the haze of the patterned light-guiding layer 20 may be maintained at less than or equal to about 15%. For example, when the maximum width W20C of the hollow area 20C is about 55 μm, the thickness T20S of the light-guiding unit 20S may be, for example, about 5 μm; when the maximum width W20C of the hollow area 20C is about 111 μm, the thickness T20S of the light-guiding unit 20S may be, for example, about 5 μm; when the maximum width W20C of the hollow area 20C is about 222 μm, the thickness T20S of the light-guiding unit 20S may be, for example, about 5 μm; when the maximum width W20C of the hollow area 20C is about 222 μm, the thickness T20S of the light-guiding unit 20S may be, for example, about 10 μm.

For example, when the hollow area 20C is a circle, the maximum width W20C of the hollow area 20C is the diameter of the circle; when the hollow area 20C is an ellipse, the maximum width W20C of the hollow area 20C may be, for example, the major axis of the ellipse, but the present disclosure is not limited thereto.

Referring again to FIG. 1, in some embodiments, the transparent projection film structure 100 further includes a scattering layer 30 disposed on the base layer 10 and including multiple scattering particles 30S, with at least some scattering particles 30S that correspond to the patterned light-guiding layer 20. As shown in FIG. 1, in this embodiment, the scattering layer 30 and the patterned light-guiding layer 20 are disposed on the same side of the base layer 10, and the scattering layer 30 is disposed on the patterned light-guiding layer 20.

As shown in FIG. 1, in this embodiment, the scattering particles 30S are located on the surface of (the light-guiding units 20S of) the patterned light-guiding layer 20. In some embodiments, the scattering particles 30S and (the light-guiding units 20S of) the patterned light-guiding layer 20 may be in direct contact, but the present disclosure is not limited thereto. In some other embodiments, an adhesive material is placed between the scattering particles 30S and the light-guiding units 20S. For example, the scattering particles 30S may first be coated on another substrate (e.g., a PET substrate) and then attached to (the light-guiding units 20S of) the patterned light-guiding layer 20 using the adhesive material.

Moreover, the scattering particles 30S include the same material as the patterned light-guiding layer 20, but the present disclosure is not limited thereto. In other words, in some embodiments, the scattering layer 30 is arranged on the surface of (the light-guiding units 20S of) the patterned light-guiding layer 20, and the distribution of the scattering particles 30S may have substantially the same profile as (the light-guiding units 20S of) the patterned light-guiding layer 20.

In some embodiments, surface treatment (e.g., surface roughening process) is performed on (the light-guiding units 20S of) the patterned light-guiding layer 20 to form the scattering particles 30S. In other words, the scattering particles 30S may be part of (the light-guiding units 20S of) the patterned light-guiding layer 20. However, the present disclosure is not limited thereto.

In some other embodiments, the scattering particles 30S include materials different from the patterned light-guiding layer 20, such as transparent micro-particles. For example, the average particle size of the scattering particles 30S is about 0.5 μm or less, and the refractive index of the scattering particles 30S is about 1.45 to about 2. Incident light passing through the scattering layer 30 (scattering particles 30S) may form diffusion, thereby reducing light spots. It should be noted that the scattering particles 30S of the scattering layer 30 may be regularly distributed or randomly distributed, and may be adjusted according to actual needs.

The transparent projection film structure 100 in this embodiment may be used in long focal length projection devices. As shown in FIG. 1, the cross-section of the light-guiding units 20S may be a trapezoid, and the included angle θ between the hypotenuse side 20SS and the base side 20SB of the light-guiding units 20S may be about 35° to about 90° (i.e.,) 35° 30≤90°. The viewer V and the projection device PJ may be located on opposite sides of the base layer 10 (i.e., back projection), and the patterned light-guiding layer 20 and the scattering layer 30 may face the projection device PJ.

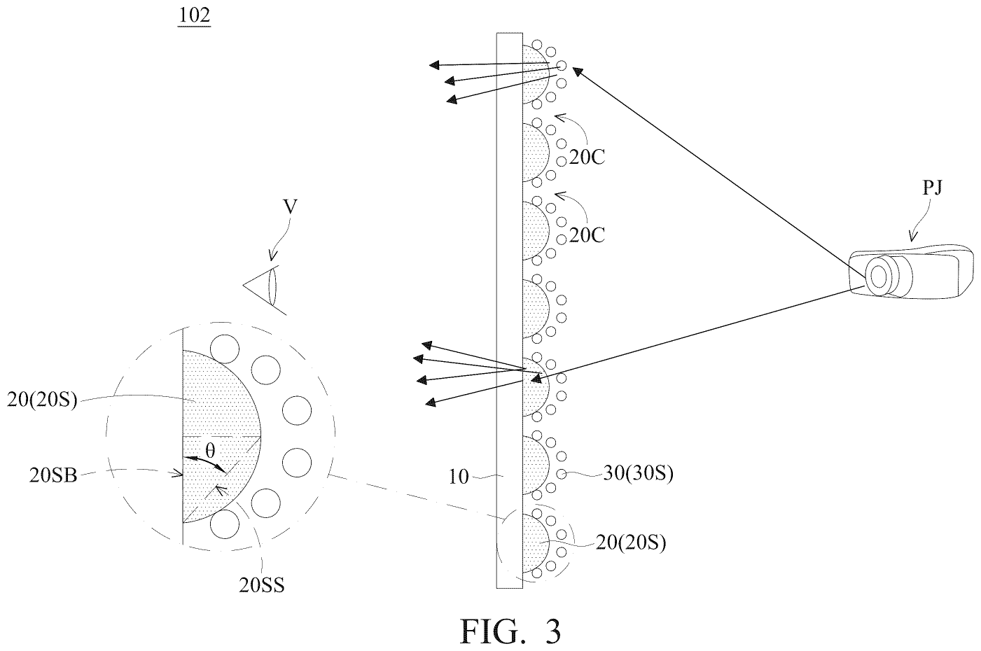

FIG. 3 is a partial cross-sectional view illustrating the transparent projection film structure 102 according to some other embodiments of the present disclosure. Similarly, some components of the transparent projection film structure 102 have been omitted in FIG. 3 for the sake of brevity.

The transparent projection film structure 102 shown in FIG. 3 has a similar structure to the transparent projection film structure 100 shown in FIG. 1. That is, in this embodiment, the transparent projection film structure 102 may include a base layer 10 and a patterned light-guiding layer 20 disposed on the base layer 10. In the cross-sectional view of FIG. 3, the patterned light-guiding layer 20 has multiple light-guiding units 20S, with multiple hollow areas 20C formed between the light-guiding units 20S. The transparent projection film structure 102 may also include a scattering layer 30 disposed on the base layer 10 and includes multiple scattering particles 30S. At least some scattering particles 30S correspond to the patterned light-guiding layer 20.

Furthermore, the partial top view of the patterned light-guiding layer 20 of the transparent projection film structure 102 may be the same or similar to FIG. 2, but the present disclosure is not limited thereto. As shown in FIG. 3, in this embodiment, the scattering layer 30 and the patterned light-guiding layer 20 are disposed on the same side of the base layer 10, and the scattering particles 30S are located on the surface of (the light-guiding units 20S of) the patterned light-guiding layer 20. Moreover, as shown in FIG. 3, in some embodiments, the light-guiding units 20S of the patterned light-guiding layer 20 are round convex.

The transparent projection film structure 102 in this embodiment may be used in long focal length projection devices. As shown in FIG. 3, the light-guiding units 20S with a round convex cross-section may form a right triangle with its arc center to the vertical plane of the base layer 10 as a reference, where the included angle θ between the hypotenuse side 20SS and the base side 20SB of the right triangle may be about 35° to about 90° (i.e.,) 35°≤θ≤90°. The viewer V and the projection device PJ may be located on opposite sides of the base layer 10 (i.e., back projection), and the patterned light-guiding layer 20 and the scattering layer 30 may face the projection device PJ.

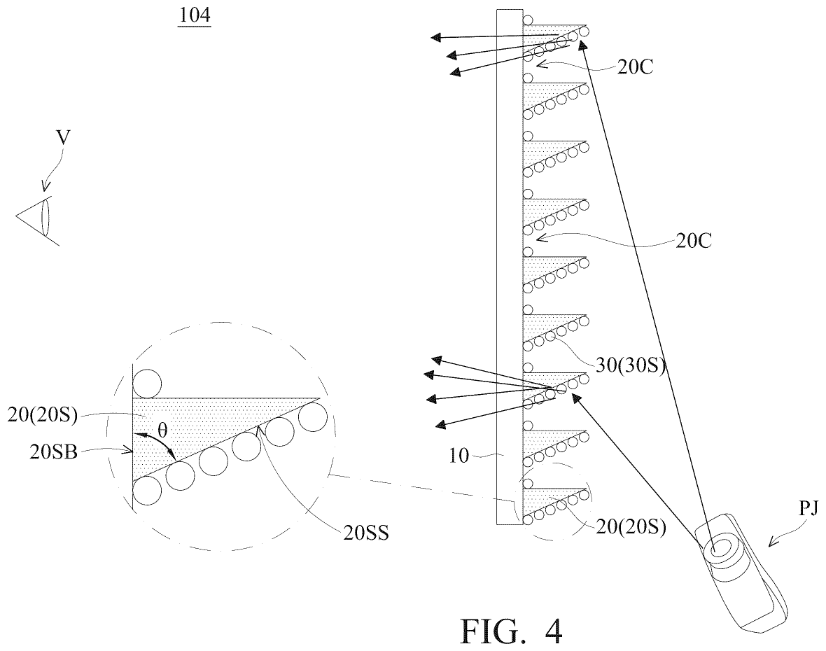

FIG. 4 is a partial cross-sectional view illustrating the transparent projection film structure 104 according to some other embodiments of the present disclosure. Similarly, some components of the transparent projection film structure 104 have been omitted in FIG. 4 for the sake of brevity.

As shown in FIG. 4, in this embodiment, the scattering layer 30 and the patterned light-guiding layer 20 of the transparent projection film structure 104 are disposed on the same side of the base layer 10, and the scattering particles 30S are located on the surface of (the light-guiding units 20S) of the patterned light-guiding layer 20. Moreover, as shown in FIG. 4, in some embodiments, the light-guiding units 20S of the patterned light-guiding layer 20 are wedge-shaped.

In this embodiment, (the light-guiding units 20S of) the patterned light-guiding layer 20 may form an asymmetric structure. Furthermore, as shown in FIG. 4, in some embodiments, the scattering particles 30S of the scattering layer 30 not only are located on the surface of the patterned light-guiding layer 20 but also on the part of the surface of the base layer 10 that is not covered by the light-guiding units 20S.

The transparent projection film structure 104 in this embodiment may be used in short focal length projection devices. As shown in FIG. 4, the light-guiding units 20S with a wedge-shaped cross-section have an included angle θ between the hypotenuse side 20SS and the base side 20SB of about 45° to about 85° (i.e.,) 45°≤θ≤85°. The viewer V and the projection device PJ may be located on opposite sides of the base layer 10 (i.e., back projection), and the patterned light-guiding layer 20 and the scattering layer 30 may be on the same side of the base layer 10 as the projection device PJ.

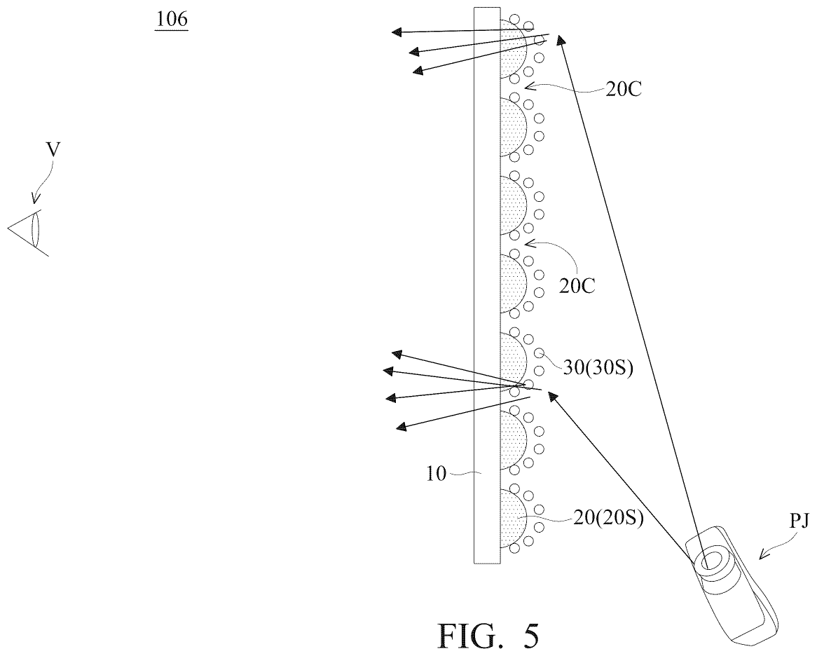

FIG. 5 is a partial cross-sectional view illustrating the transparent projection film structure 106 according to some other embodiments of the present disclosure. Similarly, some components of the transparent projection film structure 106 have been omitted in FIG. 5 for the sake of brevity.

As shown in FIG. 5, in this embodiment, the scattering layer 30 and the patterned light-guiding layer 20 of the transparent projection film structure 106 are disposed on the same side of the base layer 10, and the scattering particles 30S are located on the surface of (the light-guiding units 20S) of the patterned light-guiding layer 20. Moreover, as shown in FIG. 5, in some embodiments, the light-guiding units 20S of the patterned light-guiding layer 20 are round convex. The light-guiding units 20S shown in FIG. 5 may have a different thickness or curvature radius than the light-guiding units 20S shown in FIG. 3, but the present disclosure is not limited thereto. In other words, the shape or the size of the light-guiding units 20S may be adjusted to be suitable for different projection devices.

The transparent projection film structure 106 in this embodiment may be used in short focal length projection devices. As shown in FIG. 5, the light-guiding units 20S with a round convex cross-section may form a right triangle with its arc center to the vertical plane of the base layer 10 as a reference (not shown), where the included angle θ between the hypotenuse side 20SS and the base side 20SB of the right triangle may be about 45° to about 85°. The viewer V and the projection device PJ may be located on opposite sides of the base layer 10 (i.e., back projection), and the patterned light-guiding layer 20 and the scattering layer 30 are located on the same side of the base layer 10 as the projection device PJ.

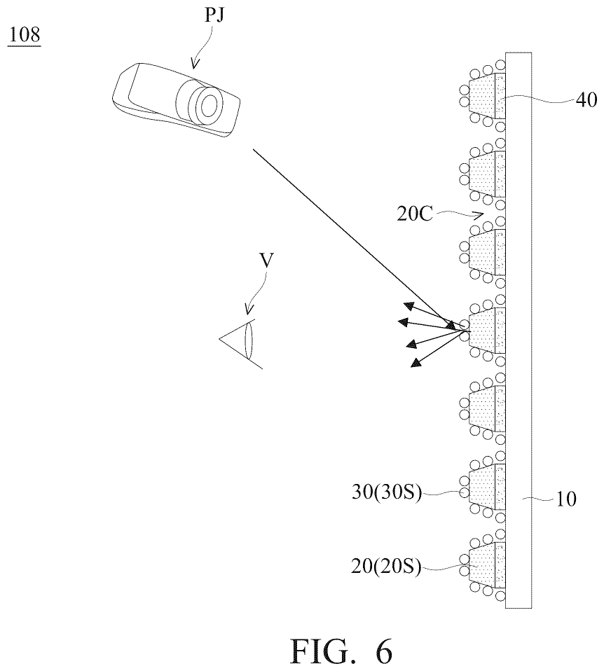

FIG. 6 is a partial cross-sectional view illustrating the transparent projection film structure 108 according to some other embodiments of the present disclosure. Similarly, some components of the transparent projection film structure 108 have been omitted in FIG. 6 for the sake of brevity.

As shown in FIG. 6, in this embodiment, the scattering layer 30 and the patterned light-guiding layer 20 of the transparent projection film structure 108 are disposed on the same side of the base layer 10, and the scattering particles 30S are located on the surface of (the light-guiding units 20S of) the patterned light-guiding layer 20. Moreover, as shown in FIG. 6, in some embodiments, the light-guiding units 20S of the patterned light-guiding layer 20 are trapezoidal.

Furthermore, as shown in FIG. 6, in some embodiments, the transparent projection film structure 108 further includes a reflective layer 40 disposed between the base layer 10 and the patterned light-guiding layer 20. That is, in some embodiments, the reflective layer 40 is arranged on the bottom surface of the patterned light-guiding layer 20. In some embodiments, the reflective layer 40 is in direct contact with the base layer 10 and the patterned light-guiding layer 20 and may have substantially the same profile as (the light-guiding units 20S of) the patterned light-guiding layer 20, but the present disclosure is not limited thereto. In some other embodiments, other components (e.g., adhesive material) may be between the reflective layer 40 and the base layer 10 (and the patterned light-guiding layer 20).

In some embodiments, the reflective layer 40 may include metal. For example, the metal may include gold (Au), nickel (Ni), platinum (Pt), palladium (Pd), iridium (Ir), titanium (Ti), chromium (Cr), tungsten (W), aluminum (Al), copper (Cu), silver (Ag), any other suitable material, an alloy thereof, or a combination thereof, but the present disclosure is not limited thereto. Moreover, the reflective layer 40 may be formed by processes including physical vapor deposition, chemical vapor deposition, atomic layer deposition, evaporation, sputtering, similar processes, or combinations thereof, but the present disclosure is not limited thereto. As shown in FIG. 6, in some embodiments, the scattering particles 30S may further be located above the reflective layer 40.

The transparent projection film structure 108 in this embodiment may be used in long focal length projection devices. As shown in FIG. 6, the light-guiding units 20S with a trapezoidal cross-section have an included angle between the hypotenuse side and the base side that may be about 35° to about 90°. As shown in FIG. 6, the viewer V and the projection device PJ may be located on the same side of the base layer 10 (i.e., front projection), and the patterned light-guiding layer 20 and the scattering layer 30 may face the projection device PJ.

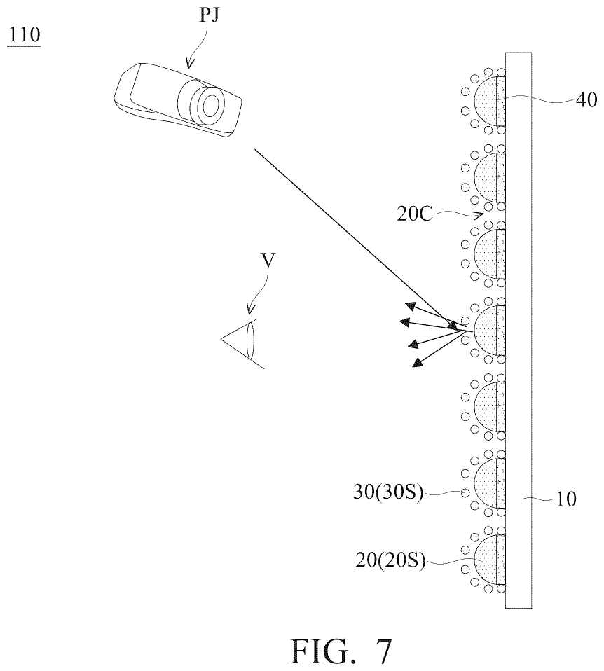

FIG. 7 is a partial cross-sectional view illustrating the transparent projection film structure 110 according to some other embodiments of the present disclosure. Similarly, some components of the transparent projection film structure 110 have been omitted in FIG. 7 for the sake of brevity.

As shown in FIG. 7, in this embodiment, the scattering layer 30 and the patterned light-guiding layer 20 of the transparent projection film structure 110 are disposed on the same side of the base layer 10, and the scattering particles 30S are located on the surface of (the light-guiding units 20S of) the patterned light-guiding layer 20. Moreover, as shown in FIG. 7, in some embodiments, the light-guiding units 20S of the patterned light-guiding layer 20 are round convex.

As shown in FIG. 7, in some embodiments, the transparent projection film structure 110 further includes a reflective layer 40 disposed between the base layer 10 and the patterned light-guiding layer 20. In some embodiments, the scattering particles 30S may further be located on the reflective layer 40.

The transparent projection film structure 110 in this embodiment may be used in long focal length projection devices. As shown in FIG. 7, the light-guiding units 20S with a round convex cross-section may form a right triangle with its arc center to the vertical plane of the base layer 10 as a reference (not shown), where the included angle between the hypotenuse side and the base side of the right triangle may be about 35° to about 90°. The viewer V and the projection device PJ may be located on the same side of the base layer 10 (i.e., front projection), and the patterned light-guiding layer 20 and the scattering layer 30 may face the projection device PJ.

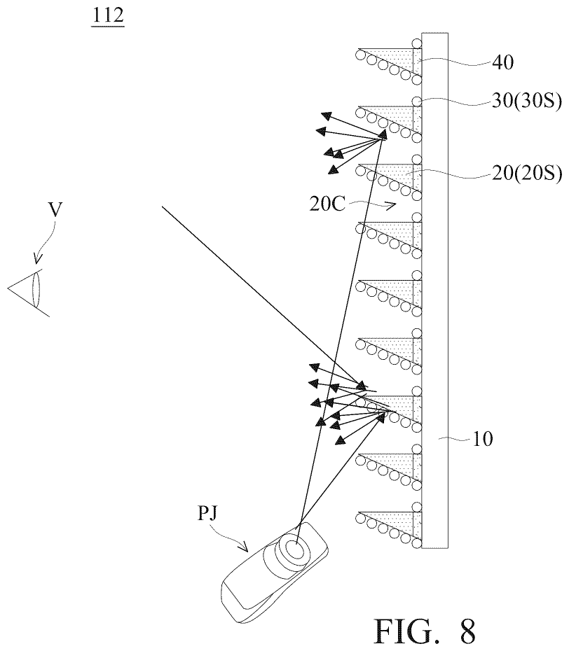

FIG. 8 is a partial cross-sectional view illustrating the transparent projection film structure 112 according to some other embodiments of the present disclosure. Similarly, some components of the transparent projection film structure 112 have been omitted in FIG. 8 for the sake of brevity.

As shown in FIG. 8, in this embodiment, the scattering layer 30 and the patterned light-guiding layer 20 of the transparent projection film structure 112 are disposed on the same side of the base layer 10, and the scattering particles 30S are located on the surface of (the light-guiding units 20S of) the patterned light-guiding layer 20. Moreover, as shown in FIG. 8, in some embodiments, the light-guiding units 20S of the patterned light-guiding layer 20 are wedge-shaped.

In this embodiment, (the light-guiding units 20S of) the patterned light-guiding layer 20 form an asymmetric structure. Moreover, as shown in FIG. 8, in some embodiments, the scattering particles 30S of the scattering layer 30 are not only located on the surface of the patterned light-guiding layer 20 but also on the part of the surface of the base layer 10 that is not covered by the light-guiding units 20S and on the reflective layer 40.

The transparent projection film structure 112 in this embodiment may be used in short focal length projection devices. As shown in FIG. 8, the light-guiding units 20S with a wedge-shaped cross-section have an included angle between the hypotenuse side and the base side of about 45° to about 85°. The viewer V and the projection device PJ may be located on the same side of the base layer 10 (i.e., front projection), and the patterned light-guiding layer 20 and the scattering layer 30 may be on the same side of the base layer 10 as the projection device PJ.

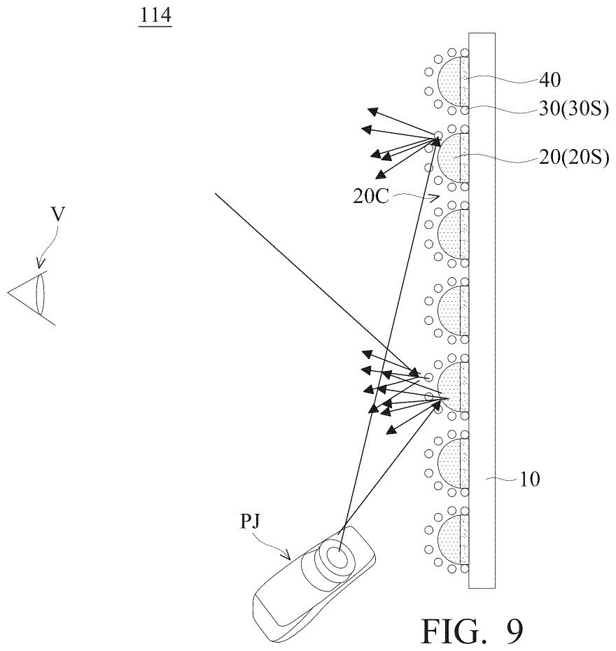

FIG. 9 is a partial cross-sectional view illustrating the transparent projection film structure 114 according to some other embodiments of the present disclosure. Similarly, some components of the transparent projection film structure 114 have been omitted in FIG. 9 for the sake of brevity.

As shown in FIG. 9, in this embodiment, the scattering layer 30 and the patterned light-guiding layer 20 of the transparent projection film structure 114 are disposed on the same side of the base layer 10, and the scattering particles 30S are located on the surface of (the light-guiding units 20S of) the patterned light-guiding layer 20. Moreover, as shown in FIG. 9, in some embodiments, the light-guiding units 20S of the patterned light-guiding layer 20 are round convex. The light-guiding units 20S shown in FIG. 9 may have a different thickness or curvature radius than the light-guiding units 20S shown in FIG. 7, but the present disclosure is not limited thereto. In other words, the shape or the size of the light-guiding units 20S may be adjusted to be suitable for different projection devices.

The transparent projection film structure 114 in this embodiment may be used in short focal length projection devices. As shown in FIG. 9, the light-guiding units 20S with a round convex cross-section may form a right triangle with its arc center to the vertical plane of the base layer 10 as a reference (not shown), where the included angle θ between the hypotenuse side 20SS and the base side 20SB of the right triangle may be about 45° to about 85°. The viewer V and the projection device PJ may be located on the same side of the base layer 10 (i.e., front projection), and the patterned light-guiding layer 20 and the scattering layer 30 may be on the same side of the base layer 10 as the projection device PJ.

As shown in FIG. 9, in some embodiments, the scattering particles 30S of the scattering layer 30 are not only located on the surface of the patterned light-guiding layer 20 but also on the part of the surface of the base layer 10 that is not covered by the light-guiding units 20S and on the reflective layer 40.

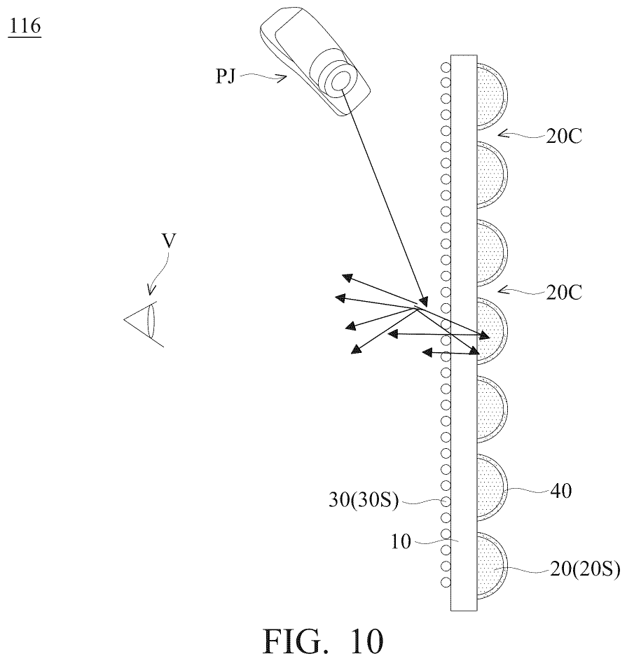

FIG. 10 is a partial cross-sectional view illustrating the transparent projection film structure 116 according to some other embodiments of the present disclosure. Similarly, some components of the transparent projection film structure 116 have been omitted in FIG. 10 for the sake of brevity.

As shown in FIG. 10, in this embodiment, the scattering layer 30 and the patterned light-guiding layer 20 of the transparent projection film structure 116 are disposed on opposite sides of the base layer 10. Moreover, the scattering layer 30 is disposed on the surface opposite the patterned light-guiding layer 20, and the scattering particles 30S distributed on the entire surface of the base layer 10. As shown in FIG. 10, in some embodiments, the light-guiding units 20S of the patterned light-guiding layer 20 are round convex.

As shown in FIG. 10, in some embodiments, the reflective layer 40 is disposed on the patterned light-guiding layer 20. The reflective layer 40 covers the surface of (the light-guiding units 20S of) the patterned light-guiding layer 20. In other words, the reflective layer 40 is arranged on the top surface of the patterned light-guiding layer 20. In some embodiments, the reflective layer 40 is in direct contact with the patterned light-guiding layer 20, and the reflective layer 40 may have substantially the same profile as (the light-guiding units 20S of) the patterned light-guiding layer 20, but the present disclosure is not limited thereto. In some other embodiments, other components (e.g., adhesive material) may be included between the reflective layer 40 and (the light-guiding units 20S of) the patterned light-guiding layer 20.

The transparent projection film structure 116 in this embodiment may be used in short focal length projection devices. As shown in FIG. 10, the light-guiding units 20S with a round convex cross-section may form a right triangle with its arc center to the vertical plane of the base layer 10 as a reference (not shown), where the included angle θ between the hypotenuse side and the base side of the right triangle may be about 45° to about 85°. Moreover, by adjusting the included angle between the hypotenuse side and the base side of the right triangle to be about 35° to about 90°, the transparent projection film structure 116 may also be used in long focal length projection devices.

As shown in FIG. 10, the viewer V and the projection device PJ may be located on the same side of the base layer 10 (i.e., front projection), the scattering layer 30 and the projection device PJ may be located on the same side of the base layer 10, and the patterned light-guiding layer 20 (and the reflective layer 40) may be located on opposite sides of the base layer 10 relative to the projection device PJ.

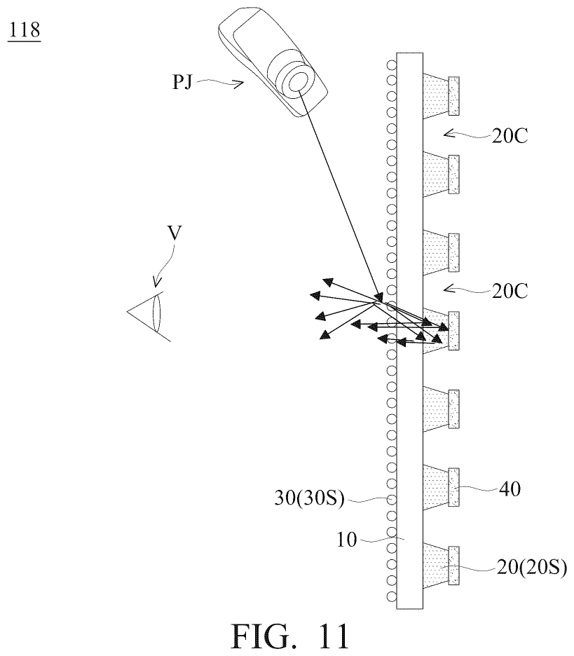

FIG. 11 is a partial cross-sectional view illustrating the transparent projection film structure 118 according to some other embodiments of the present disclosure. Similarly, some components of the transparent projection film structure 118 have been omitted in FIG. 11 for the sake of brevity.

As shown in FIG. 11, in this embodiment, the scattering layer 30 and the patterned light-guiding layer 20 of the transparent projection film structure 118 are disposed on opposite sides of the base layer 10. Moreover, the scattering layer 30 is disposed on the surface opposite the patterned light-guiding layer 20, and the scattering particles 30S are distributed on the entire surface. As shown in FIG. 11, in some embodiments, the light-guiding units 20S of the patterned light-guiding layer 20 are trapezoidal.

As shown in FIG. 11, in some embodiments, the reflective layer 40 is disposed on the patterned light-guiding layer 20. The reflective layer 40 covers the surface of (the light-guiding units 20S of) the patterned light-guiding layer 20. In other words, the reflective layer 40 is arranged on the top surface of the patterned light-guiding layer 20. In some embodiments, the reflective layer 40 may be in direct contact with the patterned light-guiding layer 20, and the reflective layer 40 may have substantially the same profile as (the light-guiding units 20S of) the patterned light-guiding layer 20, but the present disclosure is not limited thereto. In some other embodiments, other components (e.g., adhesive material) may be included between the reflective layer 40 and (the light-guiding units 20S of) the patterned light-guiding layer 20.

The transparent projection film structure 118 in this embodiment may be used in short focal length projection devices. As shown in FIG. 11, the light-guiding units 20S with a trapezoidal cross-section have an included angle between the hypotenuse side and the base side of about 45° to about 85°. However, it should be noted that the transparent projection film structure 118 may also be used in long focal length projection devices.

As shown in FIG. 11, the viewer V and the projection device PJ may be located on the same side of the base layer 10 (i.e., front projection), the scattering layer 30 and the projection device PJ may be located on the same side of the base layer 10, and the patterned light-guiding layer 20 (and the reflective layer 40) may be located on opposite sides of the base layer 10 relative to the projection device PJ.

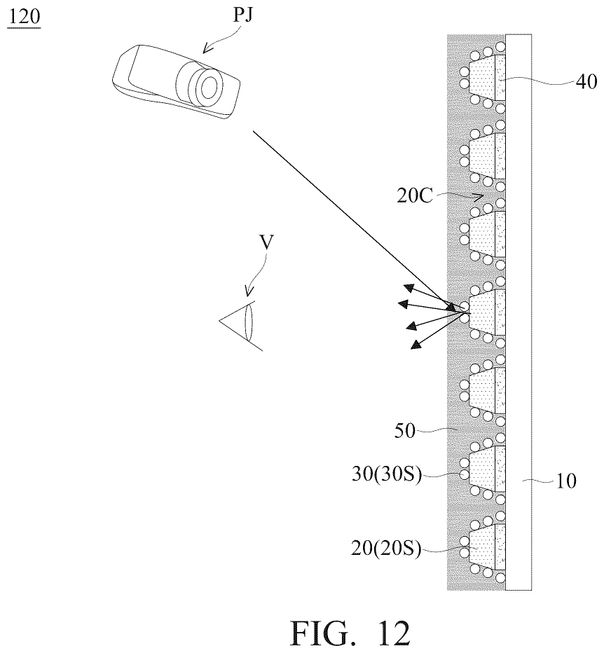

FIG. 12 is a partial cross-sectional view of illustrating the transparent projection film structure 120 according to some other embodiments of the present disclosure. Similarly, some components of the transparent projection film structure 120 have been omitted in FIG. 12 for the sake of brevity.

As shown in FIG. 12, in some embodiments, the transparent projection film structure 120 may further include a protective layer 50 disposed above the patterned light-guiding layer 20. The protective layer 50 is located on the base layer 10 and covers the patterned light-guiding layer 20 and the scattering layer 30, but the present disclosure is not limited thereto. For example, the protective layer 50 may include a transparent material with a refractive index of less than about 1.5 and may be formed above the base layer 10 by, for instance, a coating process. Then, it is cured by heating or UV irradiation to cover the patterned light-guiding layer 20 and the scattering layer 30, but the present disclosure is not limited thereto.

Furthermore, the protective layer 50 may also be incorporated in other embodiments mentioned above to further protect the patterned light-guiding layer 20 (and scattering layer 30). This will not be repeated here for the sake of brevity.

According to the embodiments of the present disclosure, the transparent projection film structure includes a patterned light-guiding layer 20 and a scattering layer 30, which may improve the projection quality and background image clarity by adjusting the density, size, and shape of the light-guiding units 20S in the patterned light-guiding layer 20 (e.g., by photolithography, nanoimprinting, precision computer numerical control (CNC) machining, injection molding, or other suitable processes) to alter the proportion of background light and projected light that is transmitted and reflected.

In some embodiments, the overall open area ratio of the transparent projection film structure may be maintained at about 75% to about 85%, with corresponding adjustments to the size of the light-guiding units 20S (e.g., the width may be about 55 μm to about 444 μm). If the size of the light-guiding units 20S is too small, the number of light-guiding units 20S per unit area may be too many, increasing the distribution density and light guiding efficiency, but the overall haze of the transparent projection film structure will also increase at the same times. If the size of the light-guiding units 20S is too large, the number of light-guiding units 20S per unit area may be too few, reducing the distribution density and light guiding efficiency, but the overall film layer haze will decrease at the same time. Therefore, an appropriate open area ratio and corresponding light-guiding unit size and/or distribution area may be designed according to actual needs.

Moreover, by changing the shape of the light-guiding units 20S, the angle of penetration/reflection of the image light source may be altered, thus affecting the image quality. Therefore, the transparent projection film structure according to the embodiments of the present disclosure may control the proportion of background light and projected light that is transmitted and reflected by adjusting the density, size, shape, and angle range of the light-guiding units 20S in the patterned light-guiding layer 20, thereby achieving excellent display quality.

Furthermore, in some embodiments, the patterned light-guiding layer 20 may include materials with high light transmittance and low color bias (ΔE (total color difference) <0.5), such as organic glass (e.g., poly(methyl methacrylate), PMMA), epoxy resin, silicone resin, polyurethane, any other suitable material, or a combination thereof, to further reduce color bias.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure. Therefore, the scope of protection should be determined through the claims and their equivalents. In addition, although some embodiments of the present disclosure are disclosed above, they are not intended to limit the scope of the present disclosure.

What is claimed is:

1. A transparent projection film structure, comprising:
a base layer;
a patterned light-guiding layer disposed on the base layer, wherein in a cross-sectional view, the patterned light-guiding layer has light-guiding units, and hollow areas are formed between the light-guiding units; and
a scattering layer disposed on the base layer and comprising a plurality of scattering particles,
wherein at least some of the plurality of scattering particles correspond to the patterned light-guiding layer.

2. The transparent projection film structure as claimed in claim 1, wherein the scattering layer and the patterned light-guiding layer are disposed on the same side of the base layer.

3. The transparent projection film structure as claimed in claim 2, wherein the scattering layer is disposed on the patterned light-guiding layer.

4. The transparent projection film structure as claimed in claim 2, wherein the plurality of scattering particles is located on a surface of the patterned light-guiding layer and comprise the same material as the patterned light-guiding layer.

5. The transparent projection film structure as claimed in claim 2, wherein in a top view, the scattering layer has the same contour as the patterned light-guiding layer.

6. The transparent projection film structure as claimed in claim 2, further comprising:
a reflective layer disposed between the base layer and the patterned light-guiding layer.

7. The transparent projection film structure as claimed in claim 6, wherein the reflective layer comprises metal.

8. The transparent projection film structure as claimed in claim 1, wherein the scattering layer and the patterned light-guiding layer are disposed on opposite sides of the base layer.

9. The transparent projection film structure as claimed in claim 8, wherein the scattering layer is disposed on a surface of the base layer, and the plurality of scattering particles is distributed on the entire surface of the base layer.

10. The transparent projection film structure as claimed in claim 8, further comprising:
a reflective layer disposed on the patterned light-guiding layer.

11. The transparent projection film structure as claimed in claim 10, wherein the reflective layer covers a surface of the patterned light-guiding layer.

12. The transparent projection film structure as claimed in claim 1, wherein a haze of the patterned light-guiding layer is less than or equal to 15%.

13. The transparent projection film structure as claimed in claim 1, wherein in a top view, the ratio of a maximum width of the hollow areas to a thickness of the light-guiding units is greater than 10:1.

14. The transparent projection film structure as claimed in claim 1, further comprising:
a protective layer disposed above the patterned light-guiding layer.

15. The transparent projection film structure as claimed in claim 1, wherein a transparency of the base layer is 30% to 95%, and a haze of the base layer is less than or equal to 5%.

16. The transparent projection film structure as claimed in claim 1, wherein each of the hollow areas is formed as a circle, an ellipse, or a polygon with internal angles greater than 135°.

17. The transparent projection film structure as claimed in claim 1, wherein each of the light-guiding units is wedge-shaped, trapezoidal, or round convex.

18. The transparent projection film structure as claimed in claim 1, wherein the light-guiding units form an asymmetric structure.

19. The transparent projection film structure as claimed in claim 1, wherein when the transparent projection film structure is used in a long focal length projection device, the included angle between the hypotenuse side and the base side of each of the light-guiding units is 35° to 90°, and when the transparent projection film structure is used in a short focal length projection device, the included angle between the hypotenuse and the base of each of the light-guiding units is 45° to 85°.

20. The transparent projection film structure as claimed in claim 1, wherein a refractive index of the patterned light-guiding layer is 1.5 to 2, and a transmittance of the patterned light-guiding layer is greater than or equal to 80%.
